(19) United States
(12) Patent Application Publication
(10) Pub. No.: US 2006/0070823 A1
(43) Pub. Date: Apr. 6, 2006

(54) Elevator capable of sterilization

(75) Inventors: Chih-Hong Huang, Taipei City (TW); Shou-Cheng Liao, Taipei City (TW)

Correspondence Address: HDSL, 4331 STEVENS BATTLE LANE, FAIRFAX, VA, 22033, US

(73) Assignee: National Taipei University Technology

(21) Appl. No.: 11/211,452

(22) Filed: Aug. 26, 2005

(30) Foreign Application Priority Data
Jun. 9, 2004 (TW) 093214166

(51) Int. Cl. B66B 11/02

(52) U.S. Cl. 187/401

(57) ABSTRACT

An elevator capable of sterilization includes sterilizers disposed on an upper and lower side of the elevator, respectively. The sterilizer may constantly operate for germ sterilizing each corner in a longitudinal well, where may not be reached by a human hand and a machine, in which the elevator moves, with the aid of the elevator moving up and down. Since a germ illuminating process is constantly made by the sterilizers, germs may be prevented from being bred and thus the purpose of sterilization of air within the longitudinal well being made prior to entering into the elevator.

### BACKGROUND OF THE INVENTION

1. Field of the Invention

The present invention relates to an elevator capable of sterilization. More particularly, the present invention relates to an elevator capable of performing a sterilization process by using an ultraviolet ray or optical-catalyzer when no person takes a ride on the elevator.

2. Description of the Prior Art

Tall buildings and high mansions have stood in great numbers. To reach up or down to a higher or lower floor from a lower or higher floor, a person generally takes a ride on an elevator. In this manner, not only time but also physical vigor may be saved. However, such elevator has a problem since it is a closed space and many people get in and off it frequently, germs may spread in the elevator if anyone therein carries such germs. Thus, other persons may possibly be undesirably infected with such germs.

When the elevator moves, air within a longitudinal well in which the elevator moves is the air source with which the air in the elevator interchanges. However, the air in the longitudinal well provides a proper environment for the germs since the longitudinal well is a closed, dark and warm and wet environment. Worse yet, no any efficient equipment or facility is provided for sanitary and sterilization with respect to the elevator. To efficiently sterilize and sanitize the elevator, illuminating each corner in the longitudinal well with an effective light source can be a solution.

From the above discussion, it can be readily known that such conventional elevator is inherent with some sanitary and sterilization problem and needs to be addressed and improved.

In view of these problems encountered in the prior art, the Inventors have paid many efforts in the related research and finally developed successfully an elevator capable of sterilization, which is taken as the present invention.

### SUMMARY OF THE INVENTION

Therefore, the present invention is to provide an elevator capable of sterilization, comprising a sterilizer disposed external thereto. The sterilizer is capable of sterilizing germs within a longitudinal well in which the elevator moves, by illuminating an effective light source on each corner in the longitudinal well, in prevention of the germs in the longitudinal well detrimental to human health and a product in the elevator.

Another, the present invention is to provide an elevator capable of sterilization which has a sterilizer configured to constantly sterilize germs within a longitudinal well in which the elevator moves so that air in the elevator may be interchanged with the air in the longitudinal well, in prevention of the germs detrimental to human health and at the gain of clean air in the elevator.

Still another, the present invention is to provide an elevator capable of sterilization, which has a sterilizer disposed on an exterior portion of the elevator so that a person or a product in the elevator may be exempted from being directly illuminated by an ultraviolet ray emitted from the sterilization. As such, a human visual organ and skin may be prevented from perpetual harm. In addition, the sterilizer may extend to a longitudinal well in which the elevator moves to sterilize germs at normal time without the presence of an operator and thus air in the elevator may be interchanged with air in the longitudinal well having been sterilized. Meanwhile, the operator, a riders or product may be exempted from damage from an ultraviolet ray emitted from the sterilizer. As such, safety guarantee may be assured.

Still another, the present invention is to provide a sterilizer capable of sterilization on and below which a sterilizer is disposed, respectively, so that air and wall in the longitudinal well may be sterilized with the aid of the elevator taking the sterilizers to each floor.

According to the present invention, the elevator capable of sterilization comprises an elevator body, sterilizers and a control panel. On an upper and lower side of the elevator, one of the sterilizers is disposed, respectively. The sterilization may constantly operate for germ sterilizing each corner in a longitudinal well, where may be not reached by a human hand and a machine, in which the elevator moves at normal time with the aid of the elevator taking the sterilizers up and down. The control panel is disposed within the elevator body so that the sterilizers may be controlled by means of machine control, automatic control with time set, elevator body transmission or intellectual control engineered by a control center of the building in which the elevator is located. Such design does not have any adverse effect upon a rider or product on the elevator. As such, air in the elevator may be interchanged with air in the longitudinal well having been sterilized. Therefore, the air in the elevator may be assured to be clean and germless.

### BRIEF DESCRIPTION OF THE DRAWINGS

The drawings disclose an illustrative embodiment of the present invention which serves to exemplify the various advantages and objects hereof, and are as follows:

FIG. 1 is a perspective view of a top side of an elevator capable of sterilization according to the present invention;

FIG. 2 is a perspective view of an elevator body of the elevator capable of sterilization according to the present invention; and

FIG. 3A and FIG. 3B are schematic diagrams illustrating a sterilization process conducted within a longitudinal well in which the elevator capable of sterilization moves according to the present invention.

### DETAILED DESCRIPTION OF THE PREFERRED EMBODIMENT

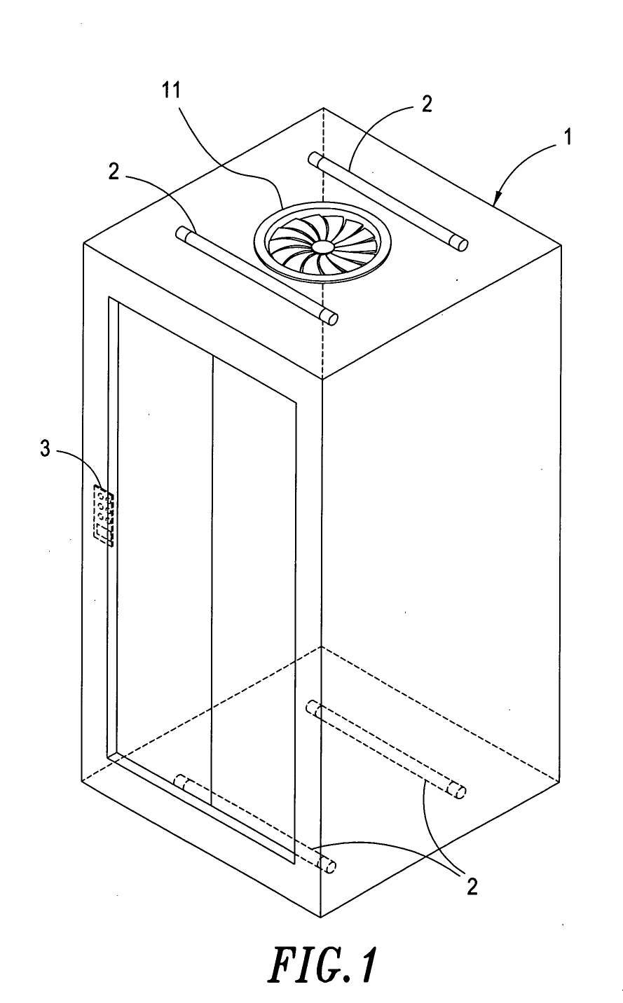

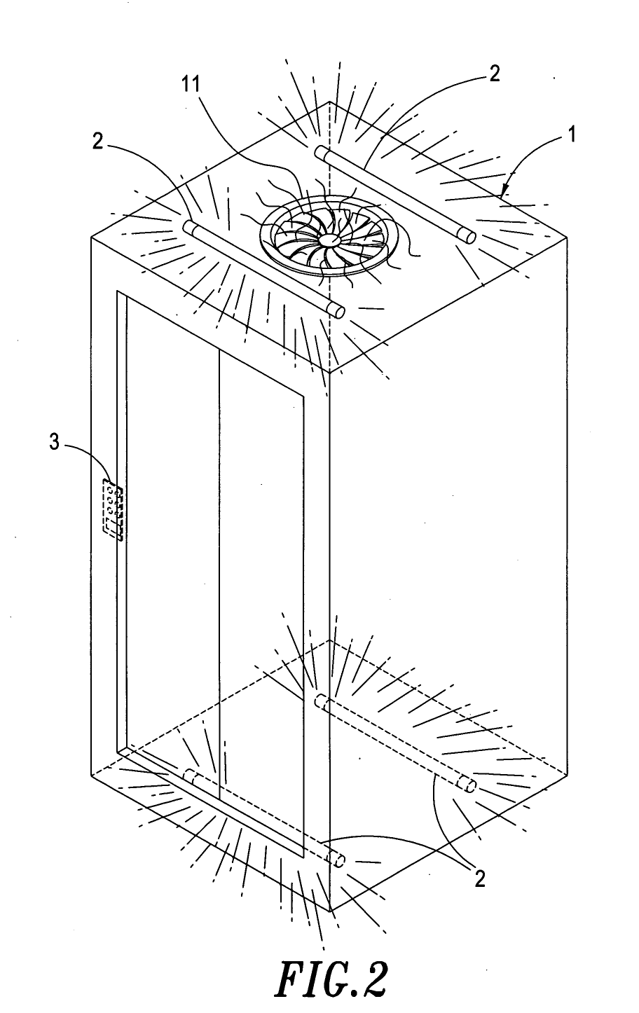

Referring to FIG. 1 through FIG. 3A and FIG. 3B, an elevator capable of sterilization according to the present invention is shown therein. As shown, the elevator comprises an elevator body 1. The elevator body 1 comprises a fan 11, sterilizers 2 and a control panel 3. The fan 11 is used to draw air within a longitudinal well 4 in which the elevator moves. The sterilizers 2 are each disposed on an upper and lower side of the elevator body 1. The sterilizers 2 may be an ultraviolet ray or an optical-catalyzer for sterilization of air within the longitudinal well 4. The control panel 3 is disposed in the elevator body 1 and through which the elevator may be machine control, automatic control with time set, elevator body transmission control or intellectual control engineered by a control center of the building where the elevator is located, which does not have an adverse effect on a rider or product on the elevator. With the above components assembled, the elevator capable of sterilization is thus formed.

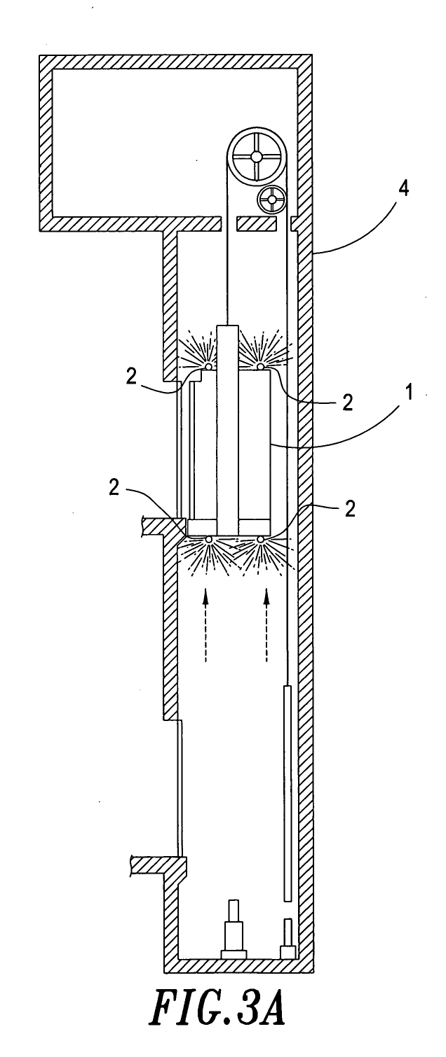

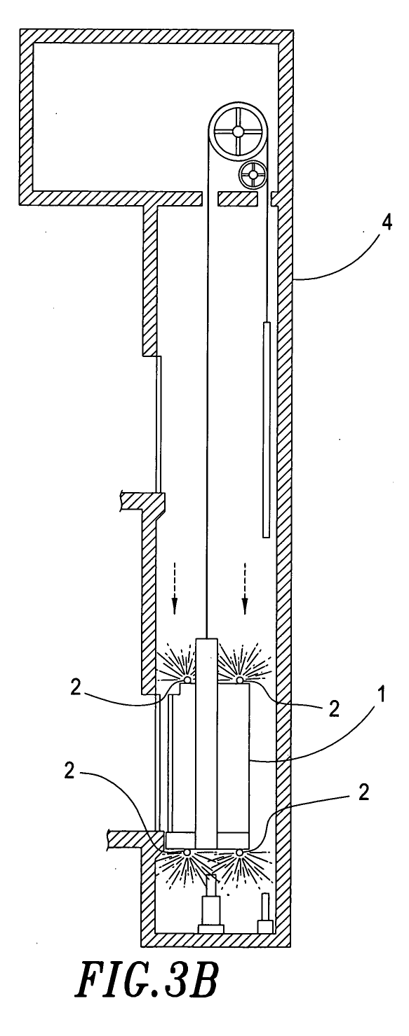

Since the air within the longitudinal well 4 is generally dirty and polluted, the air entering the elevator body 1 through the fan 11 is also not clean. To improve the air quality, the sterilizers 2 may be used to sterilizing germs bred within the longitudinal well by illuminating each corner of the longitudinal well with an ultraviolet ray with the aid of the elevator taking the sterilizers up and down along the longitudinal well. As such, the air in the longitudinal well may be sterilized prior to being drawn into the elevator body 1 (refer to FIG. 3A and FIG. 3B) and thus germs may be prevented from being bred within the longitudinal well. Therefore, it may be assured that the air entering into the elevator body 1 is clean and germless and a person taking a ride on the closed elevator body 1 may be benefited with good air quality.

<Features and Efficacies>

As compared to the prior art, the elevator capable of sterilization of this invention provides at least the following advantages and merits. 1. Since the sterilizers are disposed external to the elevator body, the sterilizers may sterilize germs within the longitudinal well by extending to each corner thereof in prevention of germs breeding therein and damage of human health or a product on the elevator. 2. Since the sterilizers constantly operate to sterilize the germs within the longitudinal well, the air in the elevator body may be interchanged with the sterilized air so that the air in the elevator is clean and may not peril human health for a person riding on the elevator. 3. By the creation where the sterilizers are disposed external to the elevator body, a person riding on the elevator may be prevented from being directly illuminated by the ultra-violet ray and thus human visual organ of the person may be prevented from perpetual harm. Further, since the sterilizers operate for sterilization of germs within the longitudinal well without the need of an operator, the operator, rider or product on the elevator may be prevented from damage of the ultraviolet ray emitted by the sterilizers. As such, optimal safety guarantee may be assured.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An elevator capable of sterilization comprising an elevator body having a fan for drawing air into the elevator body and moving longitudinally within a longitudinal well in which the elevator moves, characterized in that sterilizers are disposed on an upper and lower side of the elevator body, respectively and a control panel is disposed in the elevator body and controlled by means of machine control, automatic control with time set, elevator body transmission and intellectual control, whereby the longitudinal well is sterilized by the sterilizers at normal time with the aid of the elevator moving up and down.

2. The elevator according to claim 1, wherein said sterilizer is an ultraviolet ray or optical-catalyzer.
